(19) United States
(12) Patent Application Publication
(10) Pub. No.: US 2026/0179357 A1
(43) Pub. Date: Jun. 25, 2026

(54) TRAINING METHOD AND APPARATUS FOR IMAGE RECOGNITION MODEL, STORAGE MEDIUM, AND ELECTRONIC DEVICE

(71) Applicant: TENCENT TECHNOLOGY (SHENZHEN) COMPANY LIMITED, Shenzhen (CN)

(72) Inventors: Cheng ZHU, Shenzhen (CN); Ke YAN, Shenzhen (CN)

(21) Appl. No.: 19/309,169

(22) Filed: Aug. 25, 2025

Related U.S. Application Data
(63) Continuation of application No. PCT/CN2023/132171, filed on Nov. 17, 2023.

(30) Foreign Application Priority Data
Jun. 16, 2023 (CN) 202310731811.8

(51) Int. Cl. G06V 10/764; G06F 18/21; G06T 5/50

(52) U.S. Cl. CPC G06V 10/764; G06F 18/217; G06T 5/50

(57) ABSTRACT

A training method and apparatus for an image recognition model includes: obtaining N sample images in a first sample image set and an image description text and at least one image tag of each of the N sample images; generating, for each sample image based on the image description text and the at least one image tag of the sample image, a group of image prompts corresponding to the sample image; generating, for each sample image based on the sample image and the group of image prompts, a sample image subset corresponding to the sample image, to obtain N sample image subsets, wherein the N sample image subsets form a second sample image set; and training, by using the first sample image set and the second sample image set, an image recognition model to be trained.

### CROSS-REFERENCES TO RELATED APPLICATIONS

This application is a continuation of PCT Application No. PCT/CN2023/132171, filed on Nov. 17, 2023, which claims priority to Chinese Patent Application No. 202310731811.8, entitled “TRAINING METHOD AND APPARATUS FOR IMAGE RECOGNITION MODEL, STORAGE MEDIUM, AND ELECTRONIC DEVICE” and filed with the China National Intellectual Property Administration on Jun. 16, 2023, the entire contents of all of which are incorporated herein by reference.

### FIELD OF THE TECHNOLOGY

The present disclosure relates to the field of computers, and in particular, to a training method and apparatus for an image recognition model, a storage medium, and an electronic device.

### BACKGROUND OF THE DISCLOSURE

Currently, image classification is basically based on a deep learning classification method, which usually needs to be manually labeled, that is, images of different types needs to be correctly and accurately labeled and classified to facilitate training and prediction by using a machine learning algorithm.

However, for some image types, amounts of data (for example, data related to a sensitive problem) are relatively small. Even if quality of data labeling is relatively good, because the amounts are relatively small, the data of the types is usually overwhelmed in a large amount of data used for service training. Consequently, a recognition capability of a model for these types is relatively weak compared to the recognition capability of the model for types with greater amount of training data.

Therefore, there is a problem that an image recognition capability in a manner of training an image classification model in the related technology is relatively weak because data of a relatively small amount cannot be fully trained.

### SUMMARY

Embodiments of the present disclosure provide a training method and apparatus for an image recognition model, a storage medium, an electronic device, and a program product, to resolve at least a problem that an image recognition capability in a manner of training an image recognition model in the related technology is relatively weak because a relatively small amount of data cannot be fully trained.

According to an aspect of the embodiments of the present disclosure, a training method for an image recognition model is provided, including: obtaining N sample images in a first sample image set and an image description text and at least one image tag of each of the N sample images; generating, for each sample image based on the image description text and the at least one image tag of the sample image, a group of image prompts corresponding to the sample image; generating, for each sample image based on the sample image and the group of image prompts, a sample image subset corresponding to the sample image, to obtain N sample image subsets, wherein the N sample image subsets form a second sample image set; and training, by using the first sample image set and the second sample image set, an image recognition model to be trained. According to another aspect of the embodiments of the present disclosure, a training apparatus for an image recognition model is further provided, including: an obtaining unit, configured to obtain N sample images in a first sample image set and an image description text and at least one image tag of each of the N sample images; a first generation unit, configured to: for each sample image, generate, based on the image description text and the at least one image tag of the sample image, a group of image prompts corresponding to the sample image; a second generation unit, configured to: for each sample image, generate, based on the sample image and the group of image prompts, a sample image subset corresponding to the sample image, where the N sample image subsets form a second sample image set; and a training unit, configured to train, by using the first sample image set and the second sample image set, an image recognition model to be trained.

According to still another aspect of the embodiments of the present disclosure, a non-transitory computer-readable storage medium is further provided, the computer-readable storage medium having a computer program stored therein, and the computer program, when run, being configured for performing the foregoing training method for an image recognition model.

According to still another aspect of the embodiments of the present disclosure, an electronic device is further provided, including a memory and a processor, the memory having a computer program stored therein, and the processor being configured to perform the foregoing training method for an image recognition model by using the computer program.

### BRIEF DESCRIPTION OF THE DRAWINGS

FIG. 1 is a schematic diagram of an application environment of an exemplary training method for an image recognition model according to an embodiment of the present disclosure.

FIG. 2 is a schematic flowchart of an exemplary training method for an image recognition model according to an embodiment of the present disclosure.

FIG. 3 is a schematic flowchart of another exemplary training method for an image recognition model according to an embodiment of the present disclosure.

FIG. 4 is a schematic diagram of an exemplary training method for an image recognition model according to an embodiment of the present disclosure.

FIG. 5 is a schematic diagram of an exemplary noise addition processing method according to an embodiment of the present disclosure.

FIG. 6 is a schematic diagram of another exemplary noise addition processing method according to an embodiment of the present disclosure.

FIG. 7 is a schematic diagram of still another exemplary noise addition processing method according to an embodiment of the present disclosure.

FIG. 8 is a schematic diagram of an exemplary training method for a target text encoder and a target image encoder according to an embodiment of the present disclosure.

FIG. 9 is a schematic diagram of an exemplary training method for a generative pre-trained model according to an embodiment of the present disclosure.

FIG. 10 is a schematic diagram of an exemplary training method for visual question answering according to an embodiment of the present disclosure.

FIG. 11 is a structural block diagram of an exemplary training apparatus for an image recognition model according to an embodiment of the present disclosure.

FIG. 12 is a schematic structural diagram of an exemplary electronic device according to an embodiment of the present disclosure.

FIG. 13 is a structural block diagram of a computer system of an exemplary electronic device according to an embodiment of the present disclosure.

### DESCRIPTION OF EMBODIMENTS

To make a person skilled in the art better understand solutions of the present disclosure, the following clearly and completely describes the technical solutions in embodiments of the present disclosure with reference to the accompanying drawings in the embodiments of the present disclosure. Apparently, the described embodiments are only some of the embodiments of the present disclosure rather than all of the embodiments. All other embodiments obtained by a person of ordinary skill in the art based on the embodiments of the present disclosure without creative efforts shall fall within the protection scope of the present disclosure.

In the specification, claims, and accompanying drawings of the present disclosure, the terms “first”, “second”, and the like are intended to distinguish similar objects but do not necessarily indicate a specific order or sequence. The data used in such a way is interchangeable in proper circumstances, so that the embodiments of the present disclosure described herein can be implemented in other orders than the order illustrated or described herein. In addition, the terms “including” and “having”, and any variations thereof, are intended to cover non-exclusive inclusion, for example, a process, method, system, product, or device including a series of steps or units is not necessarily limited to those steps or units explicitly listed, but may include other steps or units not explicitly listed or inherent to these processes, methods, products, or devices.

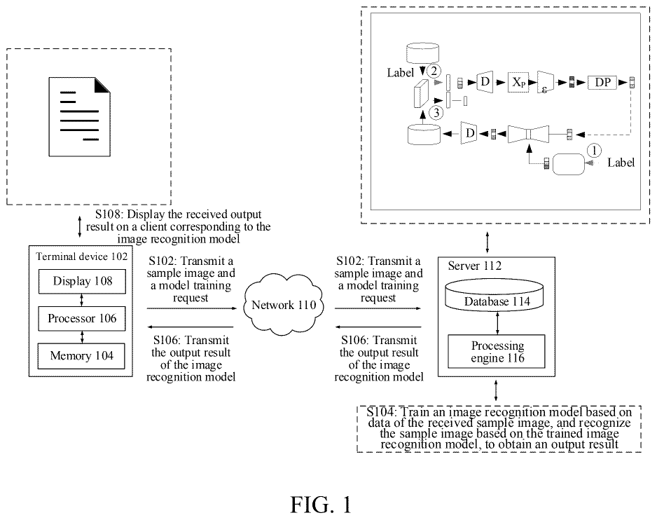

According to an aspect of the embodiments of the present disclosure, a training method for an image recognition model is provided. In some embodiments, in an exemplary implementation, the training method for an image recognition model may be applied to, but is not limited, to an environment shown in FIG. 1. The environment may include, but is not limited to, a terminal device 102, a network 110, and a server 112, where the terminal device 102 may include, but is not limited to, a display 108, a processor 106 and a memory 104.

Specific processes are as following operations.
Operation S102: The terminal device 102 transmits a sample image and a model training request to the server 112, to request training an image recognition model in the server through the sample image.

The terminal device 102 may include a client corresponding to the image recognition model, and uploading of the sample image may be completed through the client. In response to a detected image uploading operation, the terminal device 102 may transmit the sample image and the model training request to the server 112 through the network 110.
Operation S104: After receiving the sample image and the model training request, the server 112 trains the image recognition model based on data of the received sample image, and recognizes the sample image based on the trained image recognition model, to obtain an output result.

A processing engine 116 of the server 112 may first pull a model parameter corresponding to the model training request from a database 114 based on the model training request, determine the image recognition model, and input the sample image to the image recognition model, to train the image recognition model.
Operation S106: The server 112 transmits the output result of the image recognition model to the terminal device 102 through the network 110.
Operation S108: The terminal device 102 displays the received output result on the client corresponding to the image recognition model.

In some embodiments, the terminal device 102 includes, but is not limited to, at least one of the following: a mobile phone (such as an Android phone or an iOS phone), a notebook computer, a tablet computer, a palmtop computer, a mobile internet device (MID), a portable android device (PAD), a desktop computer, a smart home appliance, an in-vehicle device, a virtual reality device such as augmented reality (AR) and virtual reality (VR). The network 110 may include, but is not limited to, a wired network and a wireless network. The wired network includes: a local area network, a metropolitan area network, and a wide area network. The wireless network includes: Bluetooth, wireless fidelity (WI-FI), and another network implementing wireless communication. The server 112 may be a single server, or a server cluster including a plurality of servers, or a cloud server. The foregoing is merely an example, and this is not limited in the embodiment.

In some embodiments, the training method for an image recognition model may be performed by the server 112 alone, or may be performed by the server 112 and the terminal device 102 together, or may be performed by another electronic device other than the terminal device 102 and the server 112.

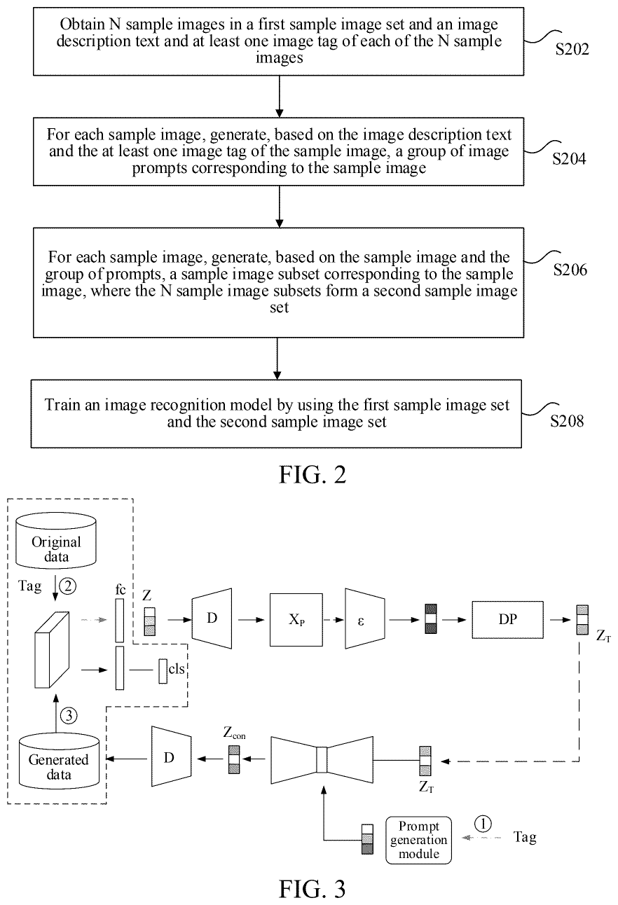

In an exemplary implementation, FIG. 2 is a schematic flowchart of an exemplary training method for an image recognition model according to an embodiment of the present disclosure. The method is executed by an electronic device, such as the server 112 shown in FIG. 1. As shown in FIG. 2, a process of the training method for an image recognition model may include the following operations:
Operation S202: Obtain N sample images in a first sample image set and an image description text and at least one image tag of each of the N sample images.

In this operation, image description texts of the N sample images and Q image tags of each sample image are obtained, where the N sample images are sample images included in the first sample image set, and N and Q are both positive integers.

In this embodiment of the present disclosure, the training method for an image recognition model may be applied to training an image classification model. The model configured for performing image classification and recognition may be a model mainly based on a deep-learning classification method. With reference to image labels, by inputting a large quantity of images of a same type into the model, the image recognition model can have a recognition capability for the images of this type. Generally, higher quality of image labeling and a larger quantity of inputted images indicate a stronger image recognition capability of the image recognition model. The image label herein may be a description of the image, for example, a sentence describing the image.

In the related technology, image labeling is usually performed manually. However, manual labeling usually needs to consume a large amount of time for collecting data and training the labeling personnel to understand a standard. The labeling time is long, and the training optimization process is slow. While high time costs and manpower costs are invested, there is a problem of mixed quality of manual labeling. Especially when launch time required by a customer is tight, there is a large problem with efficiency and quality of manual labeling, thereby affecting an effect of training the images of this type by a model. In addition, considering that actually most service data relates to sensitive problems (for example, personal privacy problems such as content review and face review), a quantity of images that can be obtained and used for model training is relatively small. Even if quality of image labeling is relatively good, in a model training process, a long tail distribution is usually formed because a quantity of images is insufficient. Consequently, optimization of effects of some types is relatively difficult.

In the related technology, for a relatively small quantity of images, a small amount of data is usually overwhelmed in a large amount of data used for service training. Consequently, a recognition capability of the model for the relatively small quantity of images of a type is relatively weak.

To resolve the foregoing technical problem, in this embodiment of the present disclosure, for a relatively small quantity of sample images, a large quantity of images of a same type as that of the sample images may be generated with reference to image tags of the sample images, to perform recognition training of the type of sample images on the image recognition model. The image tag of the sample image herein may be tag information carried in the sample image that is obtained at the same time when the sample image is obtained.

In addition, for an image related to a classification problem, an image tag of the image usually includes only one single tag, such as a knife or a fork. However, when such a small quantity of tags are inputted into a corresponding model, a success rate of image generation is very low. Even if an image is generated, a relatively large difference may exist between the generated image and an original image.

In this embodiment, for the relatively small quantity of sample images, image description texts of the N sample images and Q image tags of each sample image may be simultaneously obtained, to increase the success rate of image generation.

The N sample images herein may be sample images included in the first sample image set. The first sample image set may be a set including images of a same type.

The image description text herein may be a descriptive text of the sample image, may be a descriptive text directly generated based on the sample image, or may be automatically generated by a related model.
Operation S204: For each sample image, generate, based on the image description text and the at least one image tag of the sample image, a group of image prompts corresponding to the sample image.

To improve the success rate of image generation, a plurality of image prompts corresponding to the sample image may be first generated based on the image description text of the sample image and with reference to the image tag of the sample image. In this way, a large quantity of images of a same type are generated with reference to the plurality of image prompts, so that differences between generated new images and original images can be reduced. The image description text herein may be similar to the image prompt, and is a descriptive phrase, word, or short sentence, or the like corresponding to the image.

Using an example in which a process of generating an image by using a contrastive language-image pre-training (CLIP) model (a pre-trained model that can process a text and an image at the same time) in a stable diffusion (Sd) model (a text-to-image generation model), a prompt plays a role of constraining an image synthesis condition in an image generation process of the Sd model. In a large-scale dataset used by the CLTP model, each image includes information such as a name, a prompt, a number, a source, and a width of a pixel row, as shown in table 1 below.

TABLE 1

| | | Image | | Width of a |
|---|---|---|---|---|
| Image name | Prompt | number | Source | pixel row |
| xxxxxx.png | Small liquid sculpture, | 1050 | 2026845913 | 50 |
| | sticky reflection, | | | |
| | digital art | | | |
| xxxxxxx.png | Human body sculpture of a lanky alien | 905 | 1183522603 | 50 |
| | dating a smiling woman in an Italian | | | |
| | restaurant, | | | |
| | beautiful restaurant, | | | |
| | photography, | | | |
| | bokeh | | | |
| xxxxxxxx.png | Portrait of a savage Spanish conquistador, | 286 | 1713292358 | 50 |
| | symmetric, | | | |
| | author 1, author 2, and author 3 | | | |

In this embodiment, after the image description text and the Q image tags of the N sample images are obtained, for each of the N sample images, a group of image prompts may be generated based on the image description text corresponding to each sample image and the Q image tags corresponding to each sample image. The group of image prompts herein may include a plurality of image prompts. Correspondingly, the N sample images may have N groups of image prompts.
Operation S206: For each sample image, generate, based on the sample image and the group of image prompts, a sample image subset corresponding to the sample image, where the N sample image subsets form a second sample image set.

A new sample image corresponding to each sample image is generated based on the N groups of image prompts and the N sample images, to form the second sample image set, where the second sample image set includes the N sample image subsets, and each sample image subset is generated based on a text representation vector of one of the N groups of image prompts and an image representation vector of a corresponding sample image of the N sample images.

Because the group of image prompts may include the plurality of image prompts, a plurality of new sample images that are of a same type and that are not completely the same may be generated based on the image representation vector of the sample image and a part of image prompts in the corresponding group of image prompts, to form the sample image subset that corresponds to the sample image and that includes a plurality of images. The selected part of image prompts can be obtained by randomly inserting and combining words and sentences.

In this embodiment of the present disclosure, the image representation vector of the sample image may be an output result obtained after the sample image is inputted to the image recognition model. The image recognition model herein may be the foregoing to-be-trained image recognition model, or may be another trained image recognition model. This is not limited in this embodiment.

Operation 208: Train, by using the first sample image set and the second sample image set, the to-be-trained image recognition model.

After the second sample image set is generated, the first sample image set and the second sample image set may be jointly inputted to the to-be-trained image recognition model, to train the image recognition model. In this way, the image recognition model has strong generalization and a high recognition capability for images of a same type as that of the first sample image set.

An example in which an image is generated through the Sd model is used. In this embodiment, a process of training the image recognition model through a relatively small quantity of sample images may be shown in FIG. 3. A gray dashed line in the figure indicates that a passed parameter needs to be trained, and other dashed lines all indicate that the passed parameter is a frozen parameter. A black dashed line indicates copying of the passed parameter. Numbers 1, 2, and 3 indicate a sequence of training operations. D and F are respectively a decoder and an encoder corresponding to the Sd model, and DP is a diffusion process.

Original data 301 is a small amount of original data, or may be data which belongs to a type whose number is small in long tail learning. Generated data 302 is a prompt generated based on the original data. In combination with image data generated based on the original data, the generated data 302 is passed through a backbone network 303 to obtain a corresponding feature vector f, and then a final classification result (cls, that is, classification) may be obtained based on the feature vector f.

Dimensions of image representation vectors fc and f generated by using the generated data 302 through the backbone network 303 may be the same (for example, 16*16*1024), dimensions of an initial hidden space vector Z obtained by conversion of fc and another hidden space vector (for example, a diffuse hidden space vector Z_{T} or a target hidden space vector Z_{con}) may be the same (for example, 64*64*3), and a size of the generated data (image) obtained by decoding may be 512*512. However, to reduce a calculation amount of data, in a second operation and a third operation, a size of an image inputted to the backbone network 303 may be adjusted to a preset size (for example, 224*224).

For the data which belongs to a type whose number is small, high-dimensional feature information obtained through a diffusion model needs to be integrated, to obtain a final loss. An overall loss mainly includes a loss generated when the diffusion model is trained and a classification loss generated when the backbone network is trained. The loss generated when the diffusion model is trained may be, but is not limited to, a loss between the initial hidden space vector Z and the diffuse hidden space vector Z_{T}. For example, the initial hidden space vector Z and the diffuse hidden space vector Z_{T} are inputted to a target loss function (for example, an L1 loss function), to obtain the loss between the initial hidden space vector Z and the diffuse hidden space vector Z_{T}. The foregoing L1 loss function is configured for calculating a sum of absolute values of values taken at the same position in the initial hidden space vector Z and the diffuse hidden space vector Z_{T}, to obtain the loss between the initial hidden space vector Z and the diffuse hidden space vector Z_{T}.

The classification loss generated when the backbone network is trained may be a loss between a predicted classification tag generated when the backbone network is trained and a predetermined true classification tag. In an exemplary example, the loss may be determined through a cross entropy loss function. That is, a parameter (for example, a probability corresponding to the predicted classification tag) configured for representing the predicted classification tag and a parameter (for example, 1 or 0) configured for representing the true classification tag are inputted to the cross entropy loss function, to obtain a cross entropy value (that is, the foregoing loss). In an exemplary example, a smaller cross entropy value indicates a better prediction effect of the backbone network.

According to this embodiment provided in the present disclosure, N sample images in a first sample image set and an image description text and at least one image tag of each of the N sample images are obtained. The following processing is performed for each sample image: generating, based on the image description text and the at least one image tag of the sample image, a group of image prompts corresponding to the sample image; generating, based on the sample image and the group of image prompts, a sample image subset corresponding to the sample image, where the N sample image subsets form a second sample image set; and training, by using the first sample image set and the second sample image set, an image recognition model to be trained, to complete the conversion from a small quantity of original images to a large quantity of images of a same type. Using the large quantity of images of the same type and high quality generated to train the image recognition model, a case in which the image recognition model cannot be fully trained due to the relatively small quantity of images available for training can be avoided, so as to achieve a technical effect of improving the image recognition capability. In this way, the image recognition capability of the image recognition model is improved.

In an exemplary solution, for each of the N sample images, the generating, based on the sample image and the group of image prompts, a sample image subset corresponding to the sample image includes:
performing the following operations on an i^{th} sample image and an i^{th} group of image prompts, to obtain an i^{th} sample image subset, where i is a positive integer greater than or equal to 1 and less than or equal to N:
pre-obtaining an image representation vector of the i^{th} sample image, and determining an initial hidden space vector of the i^{th} sample image based on the image representation vector;
performing noise addition processing on the initial hidden space vector, to obtain a diffuse hidden space vector corresponding to the i^{th} sample image;
selecting Mᵢ image prompt subsets to be used from the i^{th} group of image prompts, where Mᵢ is a positive integer greater than or equal to 1;
converting each image prompt in the Mᵢ image prompt subsets into a text representation vector, to obtain Mᵢ groups of text representation vectors; and
determining, based on the Mᵢ groups of text representation vectors and the diffuse hidden space vector, Mᵢ groups of sample images corresponding to the i^{th} sample image, where the i^{th} sample image subset includes the Mᵢ groups of sample images.

When the second sample image set is generated based on the N groups of image prompts and the N sample images, an image generation operation may be separately performed on the i^{th} group of image prompts in the N groups of image prompts and the i^{th} sample image corresponding to the i^{th} group of image prompts in the N sample images, to obtain the i^{th} sample image subset. Herein, i is a positive integer greater than or equal to 1 and less than or equal to N.

The image generation operation may be the foregoing operation of combining the image representation vector with the part of image prompts in the corresponding group of image prompts, to generate the plurality of new sample images that are of the same type and that are not completely the same. That is, the Mᵢ groups of sample images corresponding to the i^{th} sample image are generated based on the image representation vector of the i^{th} sample image and the Mᵢ image prompt subsets in the i^{th} group of image prompts.

Herein, the i^{th} sample image subset includes the Mᵢ groups of sample images, Mᵢ is a positive integer greater than or equal to 1, and a quantity of image prompts included in each image prompt subset is a positive integer greater than or equal to 1.

When the Mᵢ image prompt subsets to be used are selected in the i^{th} group of image prompts, the selection may be made based on the quantity of image prompts included in each image prompt subset. To improve the accuracy of image classification, the quantity of image prompts included in each image prompt subset may be set to three or more. As shown in table 1, a plurality of prompts corresponding to an image in table 1 may be an image prompt subset. For example, “small liquid sculpture”, “sticky reflection”, and “digital art” in table 1 are three image prompts, and can form an image prompt subset.

A text image generation model that generates the sample image based on the image representation vector and the image prompt may be a diffusion model, for example, the foregoing Sd model. Because such models are usually hidden space diffusion models with conditions, in this embodiment, the image representation vector may be first converted into a hidden space vector that can be used by the model, the image prompt is converted into a text representation vector that can be combined with the hidden space vector, and then a new sample image is generated through a decoder of the diffusion model. The hidden space herein refers to high-dimensional information of an image, and is usually configured for feature alignment of generated results.

In this embodiment, the initial hidden space vector of the i^{th} sample image may be first determined based on the image representation vector of the i^{th} sample image, and then noise addition processing is performed on the obtained initial hidden space vector of the i^{th} sample image through the diffusion model, to obtain the diffuse hidden space vector corresponding to the i^{th} sample image. The process of obtaining the initial hidden space vector from the image representation vector herein may be completed based on convolution processing of the image recognition model. The diffuse hidden space vector may be configured for representing a noise image obtained by adding noise to the i^{th} sample image.

For the i^{th} group of image prompts corresponding to the i^{th} sample image, the Mᵢ image prompt subsets to be used may be selected from the i^{th} group of image prompts, and each image prompt in the Mᵢ image prompt subsets is converted into a text representation vector, to obtain the Mᵢ groups of text representation vectors.

The image prompt herein may be converted into the text representation vector through a corresponding encoding model, or the conversion from the image prompt into the text representation vector may be completed through a model that generates the image prompt at the same time when the image prompt is generated, or the conversion from the image prompt into the text representation vector may be completed through another model that can perform a prompt-to-text representation vector after the image prompt is generated. This is not limited in this embodiment.

Based on the Mᵢ groups of text representation vectors and the diffuse hidden space vector corresponding to the i^{th} sample image, the Mᵢ groups of sample images corresponding to the i^{th} sample image may be generated through denoising and decoding parts of the diffusion model. Herein, the diffuse hidden space vector corresponding to the i^{th} sample image may be combined with some text representation vectors of the Mᵢ groups of text representation vectors in a denoising process, and then the Mᵢ groups of sample images corresponding to the i^{th} sample image are generated through a decoding process.

According to this embodiment provided in the present disclosure, the image representation vector of each sample image is converted into the corresponding diffuse hidden space vector, and the new sample image is generated in combination with the text representation vector corresponding to the image prompt, so that a correlation between the generated new sample image and an original sample image can be improved.

In an exemplary solution, the determining, based on the Mᵢ groups of text representation vectors and the diffuse hidden space vector corresponding to the i^{th} sample image, the Mᵢ groups of sample images corresponding to the i^{th} sample image including:
S21: Perform the following operations on a j^{th} text representation vector of an m^{th} group of text representation vectors of the Mᵢ groups of text representation vectors and the diffuse hidden space vector, to obtain a j^{th} sample image of an m^{th} group of sample images corresponding to the i^{th} sample image, where M is a positive integer greater than or equal to 1 and less than Mᵢ, and j is a positive integer greater than or equal to 1:
performing, by using the j^{th} text representation vector and a preset first noise value set, noise reduction processing on the diffuse hidden space vector, to obtain a target hidden space vector; and
decoding the target hidden space vector, to obtain the j^{th} sample image.

In this embodiment, after the Mᵢ groups of text representation vectors and the diffuse hidden space vector corresponding to the i^{th} sample image are determined, the j^{th} text representation vector and the diffuse hidden space vector corresponding to the i^{th} sample image may be first combined, and then the j^{th} sample image is obtained by using a target hidden space vector obtained after combination through the decoding process. Herein, j is a positive integer greater than or equal to 1.

The process of combining the j^{th} text representation vector and the diffuse hidden space vector corresponding to the i^{th} sample image may be a process of performing noise reduction processing on the diffuse hidden space vector corresponding to the i^{th} sample image through the j^{th} text representation vector and the first noise value set. The target hidden space vector can be obtained through the noise reduction processing, and then the j^{th} sample image can be obtained through decoding.

Herein, noise values in the first noise value set may be determined based on noise values added to the sample image. Numerical values of different noise values may be different, and may be gradually increasing numerical values, or may be randomly changing numerical values. This is not limited in this embodiment.

According to this embodiment provided in the present disclosure, the noise reduction processing is performed, with reference to the text representation vector of the image prompt, on the image on which the noise addition processing is performed, to obtain the new sample image. In this way, a difference between the new sample image and the original sample image is kept within an appropriate range. Therefore, an effect of training the image recognition model is not poor because the difference is excessively small, nor because the difference is excessively large, the new sample image and the original sample image belong to completely different types.

In an exemplary solution, the diffuse hidden space vector represents a noise image at a t^{th} moment obtained by adding noise to the i^{th} sample image, and the performing, by using the j^{th} text representation vector and a preset first noise value set, noise reduction processing on the diffuse hidden space vector, to obtain a target hidden space vector includes:
S31: Perform, by using the j^{th} text representation vector and the first noise value set, t rounds of iterative noise reduction processing on the diffuse hidden space vector, to obtain the target hidden space vector, where t is a positive integer greater than or equal to 2, and each round of iterative noise reduction processing uses one noise value in the first noise value set.

A process of the foregoing t rounds of iterative noise reduction processing may refer to that in a case in which the diffuse hidden space vector represents the noise image at the t^{th} moment obtained by adding noise to the i^{th} sample image, noise reduction processing is performed, by using the j^{th} text representation vector and a noise value at the t^{th} moment in the first noise value set, on the diffuse hidden space vector, a result obtained through the noise reduction processing is determined as a to-be-processed hidden space vector, and repeated processing is performed, by using the j^{th} text representation vector and a noise value at a (t−1)^{th} moment, on the to-be-processed hidden space vector, until a noise value at a (t−t)^{th} moment in the noise value set is reached.

According to this embodiment provided in the present disclosure, a difference between the definition of the generated sample image and that of the original sample image may be reduced through the process of the t rounds of iterative noise reduction processing.

In an exemplary solution, the performing, by using the j^{th} text representation vector and the first noise value set, t rounds of iterate noise reduction processing on the diffuse hidden space vector, to obtain a target hidden space vector includes:
S41: Perform, by using the following operations, a q^{th} round of iterative noise reduction processing, where a (q−1)^{th} hidden space vector is outputted from a (q−1)^{th} round of iterative noise reduction processing, the (q−1)^{th} hidden space vector is configured for representing a noise image at a (t−q)^{th} moment, and q is a positive integer greater than or equal to 2 and less than or equal to t:
sequentially passing the (q−1)^{th} hidden space vector through P processing units, to obtain a q^{th} hidden space vector outputted from the q^{th} round of iterative noise reduction processing, where each processing unit includes a residual network and an attention network that are sequentially connected, an input of the attention network in each processing unit includes the j^{th} text representation vector, an input of the residual network in each processing unit includes a q^{th} noise value in the first noise value set, and P is a positive integer greater than or equal to 2.

In this embodiment, in the process of performing t rounds of iterative noise reduction processing on the diffuse hidden space vector corresponding to the i^{th} sample image, a hidden space vector inputted in each round (a diffuse hidden space vector or a hidden space vector outputted by a previous round of the round) may be sequentially passed through the P processing units. The j^{th} text representation vector is sequentially inputted while the hidden space vector is sequentially passed through the P processing units, and the inputted text representation vector is determined as a conditional constraint, to obtain a target hidden space vector of the j^{th} sample image. Herein, each processing unit may include a residual network and an attention network that are sequentially connected. An input of the attention network in each processing unit may include the j^{th} text representation vector, and P is a positive integer greater than or equal to 2.

For example, the q^{th} (q is a positive integer greater than or equal to 2 and less than or equal to t) round of iterative noise reduction processing process may be sequentially passing the (q−1)^{th} hidden space vector through the P processing units, to obtain an output result of the q^{th} round of iterative noise reduction processing: the q^{th} hidden space vector. The (q−1)^{th} hidden space vector is outputted from the (q−1)^{th} round of iterative noise reduction processing, and the (q−1)^{th} hidden space vector is configured for representing the noise image at the (t-q)^{th} moment.

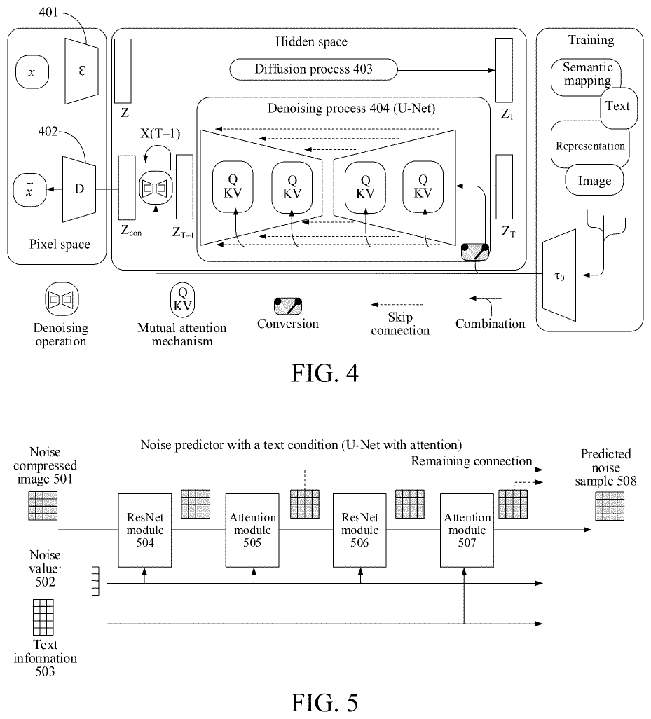

An example in which a sampling Sd model generates the j^{th} sample image is used. As shown in FIG. 4, main modules of the Sd model include an encoder (F) 401, a decoder (D) 402, a diffusion process 403, and a denoising process 404. A hidden space vector Z is obtained by using an image representation vector (for example, a feature dimension fc) of a small amount of data (for example, two or three images or even a single image provided by a client) provided by the client through the encoder (F) 401. A diffuse hidden space vector Z_{T} is obtained through the diffusion process 403. Extrapolated backwards from Z_{T}, by using a text representation vector, in the denoising process (U-shaped network, (U-Net)) 404, a target hidden space vector Z_{con} is obtained by decoding noise, and then a sample image is obtained through the decoder (D) 402. The image can be generated into a high-dimensional hidden space vector, which is usually a downsampling part of U-Net, through the encoder (F). The high-dimensional hidden space vector can be generated into the image, which is usually an upsampling part of U-Net, through the decoder (D). A U-shaped network (U-Net) model is a U-shaped based encoder-decoder network, and is a fully convolutional neural network model.

According to this embodiment provided in the present disclosure, a hidden space vector corresponding to an original sample image is sequentially passed through P processing units, and the inputted text representation vector is determined as a conditional constraint, to obtain a target hidden space vector of the original sample image. Further, the target hidden space vector of the original sample image is decoded to generate a new sample image. In this way, a correlation between the target hidden space vector and the original sample image can be improved, thereby improving a correlation between the generated sample image and the original sample image.

In an exemplary solution, the sequentially passing the (q−1)^{th} hidden space vector through P processing units, to obtain a q^{th} hidden space vector outputted from the q^{th} round of iterative noise reduction processing includes:
S51: Process, by using a first residual network in the first processing unit of the P processing units based on the q^{th} noise value, the (q−1)^{th} hidden space vector, to obtain a residual result outputted by the first residual network.
S52: Process, by using a first attention network in the first processing unit, the residual result outputted by the first residual network and the j^{th} text representation vector, to obtain a q^{th} hidden space vector outputted by the first attention network.
S53: Perform the following operations by using a k^{th} processing unit of the P processing units, where k is a positive integer greater than or equal to 2 and less than or equal to P, and an input of a residual network in each processing unit includes the q^{th} noise value:
processing, by using a k^{th} residual network in the k^{th} processing unit based on the q^{th} noise value, a qₖ₋₁^{th} hidden space vector outputted by a (k−1)^{th} attention network in a (k−1)^{th} processing unit, to obtain a residual result outputted by the k^{th} residual network; and
processing, by using a k^{th} attention network in the k^{th} processing unit, the residual result outputted by the k^{th} residual network and the j^{th} text representation vector, to obtain a qₖ^{th} hidden space vector outputted by the k^{th} attention network, where when k is equal to P, the q^{th} hidden space vector is a q_{P}^{th} hidden space vector outputted by a P^{th} attention network.

In this embodiment, in the process of sequentially passing the (q−1)^{th} hidden space vector through the P processing units, the (q−1)^{th} hidden space vector may be first passed through the residual network in the processing unit, and then passed through the attention network in the processing unit. The q^{th} noise value is inputted by using the first residual network in the first processing unit of the P processing units, and the (q−1)^{th} hidden space vector is processed, to obtain the residual result outputted by the first residual network. Then, the residual result outputted by the first residual network and the j^{th} text representation vector are processed by using the first attention network in the first processing unit, to obtain the q₁^{th} hidden space vector outputted by the first attention network.

The operation of performing the following operations, by using a k^{th} processing unit (k is a positive integer greater than or equal to 2 and less than or equal to P) after the first processing unit of the P processing units, on the (q−1)^{th} hidden space vector may include: processing, by using the k^{th} residual network in the k^{th} processing unit based on a preset noise value, the qₖ₋₁^{th} hidden space vector outputted by the (k−1)^{th} attention network in the (k−1)^{th} processing unit, to obtain the residual result outputted by the k^{th} residual network; and then processing, by using the k^{th} attention network in the k^{th} processing unit, the residual result outputted by the k^{th} residual network and the j^{th} text representation vector, to obtain the qₖ^{th} hidden space vector outputted by the k^{th} attention network. Correspondingly, when k is equal to P, the q^{th} hidden space vector may be the q_{P}^{th} hidden space vector outputted by the P^{th} attention network.

In this embodiment, the residual network in the processing unit refers to a residual network module, and the attention network in the processing unit refers to an attention network module. Correspondingly, the residual network and the attention network that are sequentially connected refer to that the residual network module and the attention network module are sequentially connected, that is, an attention module is sequentially added to each residual network module of a complete residual network.

An example in which a U-Net model is determined as a model for processing a sample image is used. As a core building block (that is, a module in the processing unit) of U-Net, the residual network may be a residual network (ResNet) module, and the attention network may be an attention module. Because the ResNet module cannot directly process a text vector, the text representation vector can be integrated into the image representation vector by combining each ResNet module with an attention module that can process the text vector.

As shown in FIG. 5, a noise compressed image Z_{T} (that is, a diffuse hidden space vector of a sample image after diffusion processing) 501 and a noise value 502 (determined based on a noise value that is inputted in a diffusion process and that is at a moment T) are inputted into a ResNet module 504. A residual result outputted by the ResNet module 504 connected to an attention module 505 is inputted to the attention module, and text information (that is, a text representation vector) 503 is injected to the attention module. In a U-Net denoising process, the text representation vector is continuously injected to the denoising process through an attention mechanism. Each ResNet module is no longer directly connected to an adjacent ResNet module, but an attention module is newly added in the middle. Referring to a ResNet module 506 and an attention module 750, the text representation vector is processed through the attention module, to continuously inject the text information, thereby completing combination of a hidden space vector of an image and the text representation vector. A result obtained through each processing unit is connected and integrated to output a predicted noise sample Z_{T-1} 508.

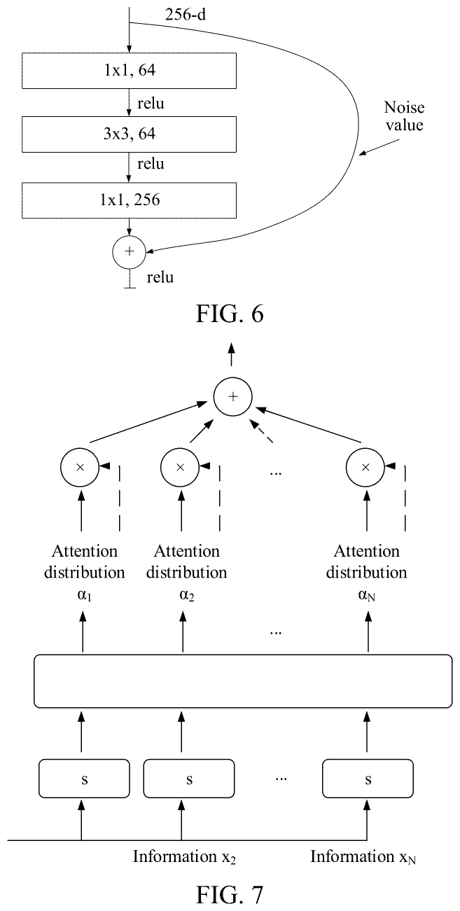

In the foregoing process of processing the hidden space vector of the image and the noise value in a ResNet module, as shown in FIG. 6, an image vector can be obtained after the hidden space vector of the image is subjected to a plurality of times of convolution processing performed by a convolution layer in the ResNet module. The inputted noise value and the image vector are processed by a fully connected layer under the influence of an activation function, to obtain a residual result.

A process of processing the residual result and the text representation vector in an attention module may be shown in FIG. 7. The attention module may separately calculate an attention distribution of the residual result and the text representation vector, and perform weighted averaging, to obtain a predicted noise sample.

The foregoing U-Net denoising may be a process of multiple cycles. That is, the outputted predicted noise sample is determined as input data for denoising again, and a predicted noise sample Z_{T-1} and a noise value corresponding to a moment T−1 are inputted in ResNet, to obtain a predicted noise sample Z_{T-2}. Then, the predicted noise sample Z_{T-2} is determined as new input data, until a predicted noise sample Z_{T-}T is obtained, that is, a target hidden space vector (Z_{con}) of a j^{th} sample image corresponding to an i^{th} sample image.

The diffusion model is usually divided into a forward process (a diffusion process) and a restoration process. The diffusion process is a noise addition process. The restoration process is a noise removal process. The operation performed in this embodiment is the noise removal process with reference to the text representation vector, that is, a sample image restoration (generation) process with reference to the text representation vector.

According to this embodiment provided in the present disclosure, the text representation vector is injected to the denoising process through the attention network, so that the text representation vector and the image hidden space vector can be combined in the denoising process, to generate the new sample image corresponding to the sample image based on different text representation vectors, thereby improving generation efficiency of the sample image.

In an exemplary solution, the determining an initial hidden space vector of the i^{th} sample image based on the image representation vector of the i^{th} sample image includes:
S61. Process the image representation vector of the i^{th} sample image through the residual network, to obtain the initial hidden space vector of the i^{th} sample image.

The obtained image representation vector of the i^{th} sample image may be converted, through the residual network, into the initial hidden space vector of the i^{th} sample image needed by the diffusion model. The conversion process may be a process of processing the image representation vector of the i^{th} sample image through a convolution layer and a fully connected module of the residual network. After the image representation vector of the i^{th} sample image is averaged, the initial hidden space vector is obtained through the fully connected module.

An example in which the residual network is resnet50 (a residual network including 49 convolutional modules and one fully connected module) is used. An output result obtained by inputting the i^{th} sample image to resnet50 may be the image representation vector of the i^{th} sample image, a feature dimension fc of the image representation vector may be 16*16*1024. A feature is averaged, and the initial hidden space vector Z is obtained through the fully connected module. The feature dimension of Z may be 64*64*3.

According to this embodiment provided in the present disclosure, the image representation vector is converted, through the residual network, into the initial hidden space vector needed by the diffusion model, so that the success rate of generating the new sample image by the diffusion model can be improved.

In an exemplary solution, the performing noise addition processing based on the initial hidden space vector of the i^{th} sample image, to obtain a diffuse hidden space vector corresponding to the i^{th} sample image includes:
S71: Decode the initial hidden space vector of the i^{th} sample image, to obtain an i^{th} to-be-processed image corresponding to the i^{th} sample image.
S72: Encode the i^{th} to-be-processed image, to obtain an image representation vector of the i^{th} to-be-processed image.
S73: Perform noise addition processing on the image representation vector of the i^{th} to-be-processed image, to obtain the diffuse hidden space vector corresponding to the i^{th} sample image.

Considering that a model configured for adding noise and denoising and a model configured for performing feature extraction on the sample image may be different models, after the image representation vector of the sample image is obtained based on the model configured for performing feature extraction on the sample image, to obtain the initial hidden space vector, decoding and encoding processing may be first performed on the initial hidden space vector, to convert the initial hidden space vector into a space vector that can be identified and processed by the model configured for adding noise and denoising.

In this embodiment, the obtained initial hidden space vector of the i^{th} sample image may be first decoded through the decoder, to obtain the i^{th} to-be-processed image corresponding to the i^{th} sample image, and then the i^{th} to-be-processed image is encoded, to obtain the image representation vector of the i^{th} to-be-processed image.

Because the initial hidden space vector may be converted based on a reduced-size image through the image representation vector generated by using the foregoing backbone network, to enable that a sample image generated based on the diffuse hidden space vector and the text representation vector has a higher resolution and similarity to the original sample image while converting the initial hidden space vector into the space vector that can be identified and processed by the model configured for adding noise and denoising, in the foregoing decoding process of the initial hidden space vector, a size of a corresponding image may be expanded, that is, a size of the to-be-processed image may be larger than a size of the inputted sample image (that is, the sample image inputted into the foregoing backbone network). In other words, after the obtained sample image is adjusted to the preset size (for example, 224*224) based on the descriptions of the foregoing embodiments and is inputted into the backbone network, the obtained sample image is decoded by the decoder, so that the size of the obtained to-be-processed image becomes larger (for example, 512*512). The process of encoding the to-be-processed image to obtain the image representation vector may be the same as the foregoing process of encoding the sample image to obtain the image representation vector of the sample image, and may be through the same encoder.

Noise addition processing (that is, diffusion processing) may be performed on the obtained image representation vector of the i^{th} to-be-processed image, to obtain the diffuse hidden space vector corresponding to the i^{th} sample image. The noise value inputted in the diffusion process may be configured for the foregoing noise value inputted into the residual network of each processing unit.

According to this embodiment provided by the present disclosure, the initial hidden space vector of the sample image is first converted into the to-be-processed image, and then the diffuse hidden space vector is generated through the noise addition process, so that a problem that an image cannot be generated or a generated image greatly differs from an original image due to that diffusion processing is directly performed on the initial hidden space vector can be avoided, thereby improving generation accuracy of the new sample image.

In an exemplary solution, the performing noise addition processing on the image representation vector of the i^{th} to-be-processed image, to obtain the diffuse hidden space vector corresponding to the i^{th} sample image includes:
S81: Perform, by using a preset second noise value set, t rounds of iterative noise addition processing on the image representation vector of the i^{th} to-be-processed image, to obtain the diffuse hidden space vector corresponding to the i^{th} sample image, where t is a positive integer greater than or equal to 2, and each round of iterative noise addition processing uses a corresponding noise value in the second noise value set.

In this embodiment, noise addition processing performed on the image representation vector of the i^{th} to-be-processed image may be t rounds of iterative noise addition processing performed by using the second noise value set. Herein, t may be a positive integer greater than or equal to 2. The second noise value set may include different noise values, and may be the same as the noise values in the first noise value set. The second noise value may be a noise value obtained through random sampling, or may be a Gaussian noise predicted through a corresponding neural network learning model.

After the image representation vector of the i^{th} to-be-processed image is obtained, noise addition processing may be performed on the image representation vector of the i^{th} to-be-processed image by using a corresponding noise value in the second noise value set, to obtain a noisy image representation vector. In each subsequent round of iterative noise addition processing, noise addition processing is performed, by using a corresponding noise value in the second noise value set, on a noisy image representation vector obtained after a previous round of noise addition of the round. The noise value used in the t rounds of noise addition processing processes may increase as the round increases.

In some embodiments, the t rounds of noise addition processing performed on the image representation vector of the i^{th} to-be-processed image by using the second noise value set may alternatively not be iterative, that is, each round of noise addition processing is performed on the image representation vector of the i^{th} to-be-processed image.

An example in which the image representation vector of the i^{th} to-be-processed image is x₀ is used. The t rounds of noise addition processing performed on x₀ may be shown in formula (1):

$$q ( {x}_{t} \vert {x}_{0} ) = N ( {x}_{t} ; \sqrt{{\overline{α}}_{t}} {x}_{0} , ( 1 - {\overline{α}}_{t} ) I ) \qquad ( 1 )$$

where q(xₜ|x₀) refers to that xₜ is obtained by adding a Gaussian noise to an image x₀. Formula (1) may be a Gaussian distribution of a mean μ=−\sqrt{α̅}x₀ and a variance σ²=1−βₜ.

Formula (1) may be converted into manners shown in formulas (2), (3), and (4):

$${β}_{t} < … < {β}_{T} {α}_{t} = 1 - {β}_{t} {\overline{α}}_{t} = {\prod }_{i = 1}^{T} {α}_{t} \qquad ( 2 )$$

$${x}_{t} = \sqrt{{\overline{α}}_{t}} {x}_{0} + \sqrt{1 - {\overline{α}}_{t}} {ϵ}_{t} \qquad ( 3 )$$

$${x}_{0} = \frac{1}{\sqrt{{\overline{α}}_{t}}} ( {x}_{t} - \sqrt{1 - {\overline{α}}_{t}} {ϵ}_{t} ) \qquad ( 4 )$$

Specifically, during calculation in each operation, a two-dimensional standard Gaussian distribution ∈−N(0,I) may be first sampled, and then xₜ is obtained by using x₀ through a parameter at.

According to this embodiment provided by the present disclosure, by performing multiple rounds of noise addition processing on the image representation vector of the i^{th} to-be-processed image, image data can be completely changed to a pure noise image, so that image generation is implemented through a reverse denoising process.

In an exemplary solution, the converting each image prompt in the Mᵢ image prompt subsets into a text representation vector, to obtain Mᵢ groups of text representation vectors includes:
S91: Encode, by using a target text encoder, each image prompt in the Mᵢ image prompt subsets, to obtain the Mᵢ groups of text representation vectors.

In an exemplary solution, the pre-obtaining an image representation vector of the i^{th} sample image includes:
S111: Encode the i^{th} sample image by using a target image encoder, to obtain the image representation vector.

The target text encoder and the target image encoder are encoders obtained by performing joint training on a to-be-trained text encoder and a to-be-trained image encoder.

During training, the target text encoder and the target image encoder meet the following conditions.

A similarity between a first text representation vector and a first image representation vector is less than or equal to a preset first threshold. The first text representation vector is a vector obtained by encoding text information in a first group of information by the target text encoder. The first image representation vector is a vector obtained by encoding an image in the first group of information by the target image encoder. The text information in the first group of information does not match the image.

A similarity between a second text representation vector and a second image representation vector is greater than or equal to a preset second threshold. The second text representation vector is a vector obtained by encoding text information in a second group of information by the target text encoder. The second image representation vector is a vector obtained by encoding an image in the second group of information by the target image encoder. The text information in the second group of information matches the image, and the second threshold is greater than the first threshold.

In this embodiment, each image prompt in the Mᵢ image prompt subsets is converted into the text representation vector, which may be obtained by encoding each image prompt by the target text encoder. The target text encoder and the target image encoder are encoders obtained by performing joint training on a to-be-trained text encoder and a to-be-trained image encoder. Herein, the target image encoder may be the foregoing encoder that encodes the sample image to obtain the image representation vector.

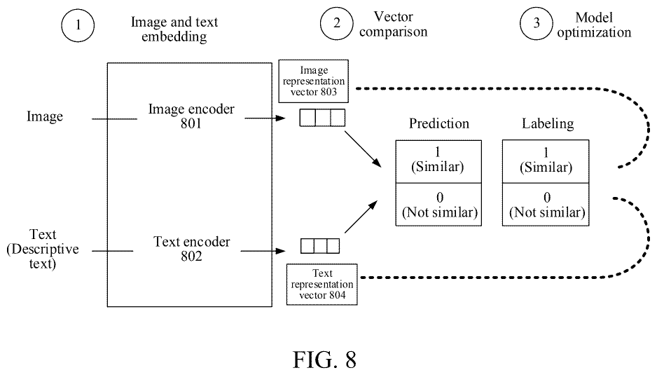

The target text encoder and the target image encoder may be different encoders belonging to a same model, for example, a text encoder and an image encoder of a CLIP model. As shown in FIG. 8, a text encoder 801 may convert a text into a text representation vector (text embedding), and an image encoder 802 may convert an image into an image representation vector (image embedding).

After conversion from a tag into a prompt is completed through a prompt generation module, the text encoder 801 of CLIP is first used to compress the prompt into an image representation vector 803, to be used for text input during vector comparison in a second operation (based on a diffusion model herein, a common logical data model (LDM) model and a stable diffusion model are selected), so that the diffusion model has stronger condition constraint information.

Using the CLIP model as an example, the CLIP model includes an image encoder and a text encoder. A training process of the CLIP model may include: first randomly extracting an image and a section of text from a training set (the text does not necessarily match the image, and a task of the CLIP model is to predict whether the image matches the text, thereby starting training). After the text and the image are randomly extracted, the text and the image are respectively compressed into two representation vectors, that is, the image representation vector 803 and a text representation vector 804 (as two 3*1 vectors shown in FIG. 8), through the image encoder and the text encoder.

A similarity between the two representation vectors is obtained through comparison by using a cosine similarity, to determine whether the randomly extracted text matches the image. At the beginning of training, even if the image and the text actually match well, because the two encoders have just been initialized and parameters are chaotic, the two representation vectors are also chaotic, and a calculated similarity is usually close to 0. That is, the image and the text are a pair of data, tags of the image and the text are similar, but prediction results obtained through cosine similarity calculation are not similar. Parameters of the two encoders may be reversely updated based on a mismatching result between a tag similarity and a prediction result dissimilarity.

The foregoing reverse propagation process is continuously repeated, so that the two encoders can be trained. For matched images and texts, at the end of training, the two encoders may output similar representation vectors, and the calculated cosine similarity may be close to 1. For unmatched images and texts, at the end of training, the two encoders may output representation vectors having a large difference, and the calculated cosine similarity is close to 0. After the training is completed, for example, if an image of a puppy is inputted into the CLIP model, and a description of a text is provided: “a photo of a puppy”, the CLIP model generates two similar representation vectors, to determine that the text matches the image.

In the foregoing training manner, two pieces of originally irrelevant information, which are computer vision and a human language, may be connected through CLIP and have a unified mathematical representation. In CLIP, a text may be converted into image information through a text encoder, or a text may be converted into language information through an image encoder. This is a core in the diffusion model that can generate an image through a text.

According to this embodiment provided in the present disclosure, generation of the image prompt to the text representation vector is completed by the jointly trained text encoder and the text encoder in the image encoder, so that a success rate of generating the matched image through the text representation vector can be improved.

In an exemplary solution, the generating N groups of image prompts based on image description texts of the N sample images and the Q image tags includes:
S121: Perform the following operations on an image description text of an i^{th} sample image of the N sample images and an i^{th} image tag of the Q image tags, to obtain an i^{th} group of image description text prompts, where i is a positive integer greater than or equal to 1 and less than or equal to N:
S123: Input, as a target question, the image description text and the i^{th} image tag to a generative pre-trained model, to obtain an i^{th} image prompt, where the generative pre-trained model is configured for generating a corresponding answer based on an inputted question, and i is a positive integer greater than or equal to 1.

In this embodiment, when the N groups of image prompts are generated based on the image description texts of the N sample images and the Q image tags, a target question corresponding to the i^{th} sample image may be inputted into the generative pre-trained model, and a corresponding image prompt is generated based on the image description text of the i^{th} sample image and the i^{th} image tag. Herein, i is a positive integer greater than or equal to 1 and less than or equal to N. The generative pre-trained model may be configured for generating a corresponding answer based on an inputted question. The target question corresponding to the i^{th} sample image may be configured for requesting to generate the corresponding image prompt based on the image description text of the i^{th} sample image and the i^{th} image tag.

In some embodiments, the image description text of the i^{th} sample image may be an image description text obtained by inputting the i^{th} sample image into a text generation model. The text generation model may be configured for generating an image description text based on an inputted image.

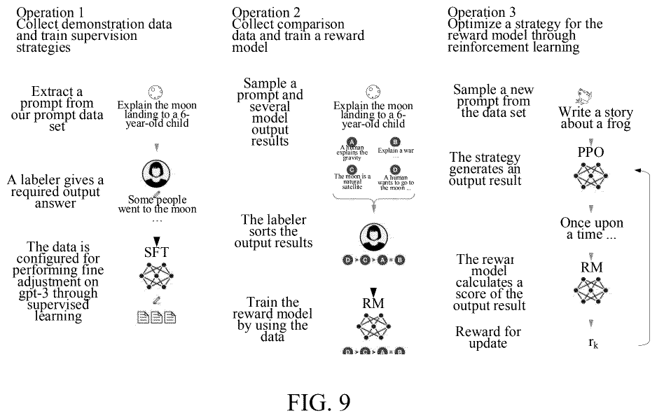

The foregoing generative pre-trained model may be a language model configured for generating sentence dialog information, for example, a chat generative pre-trained transformer (Chatgpt) model. An example in which the generative pre-trained model is the Chatgpt model is used. As shown in FIG. 9, the Chatgpt model mainly completes model optimization through three operations, including:
Operation 1: Complete fine model adjustment by collecting demonstration data and training supervision strategies.
Operation 2. Train a reward model by collecting comparison data.
Operation 3. Optimize a strategy for the reward model through reinforcement learning.

Because it is difficult to understand and process visual information only based on a question and answer of the text, iterative processing may be performed through the generative pre-trained model and an input text generation model, to implement visual understanding on a sample image.

The generative pre-trained model may be determined as a conversion tool to receive an image tag of the inputted sample image, and generate a prompt corresponding to the sample image based on the question and answer of the text. The language model configured for visual and language pre-training, as a model that can understand and process vision, can generate a corresponding visual description sentence (that is, an image description text) based on then inputted sample image. By combining the two models, a more accurate image description text can be generated based on the sample image.

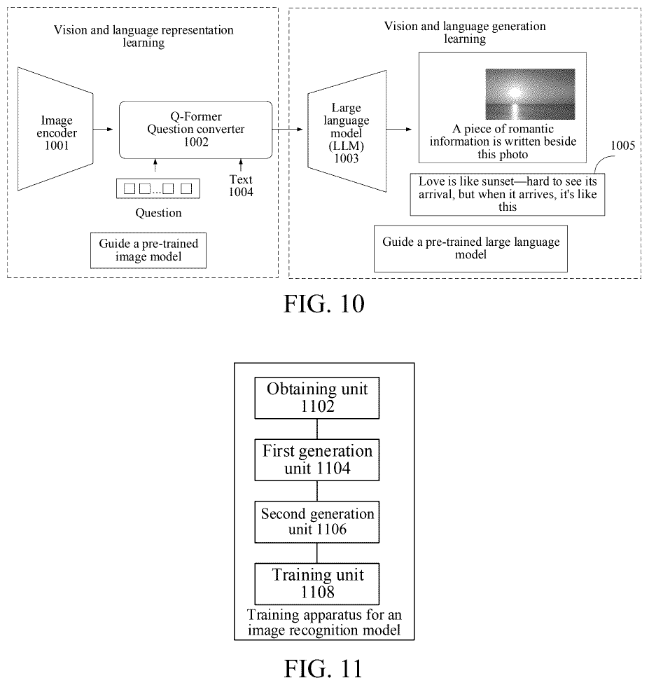

An example in which the text generation model is a BLIP-2 model is used. As shown in FIG. 10, the BLIP-2 model introduces a large language model (LLM), and adds a lightweight query transformer (Q-Former) model 1002 between a frozen pre-trained image encoder 1001 and a frozen pre-trained LLM 1003, to bridge a modal gap between visual and language models. In the entire model, the Q-Former 1002 is the only trainable module, and the image encoder 1001 and LLM always remain in a frozen state. An image is inputted into the image encoder 1001, an output result is integrated with a text 1004 in the Q-Former 1002, and finally, the output result is transmitted to the LLM model 1003, to generate a description 1005 of the image.

Chatgpt is used as a conversion tool. Unpopular tags corresponding to a small quantity of sample images are inputted, multiple rounds of iterative interactions are performed through BLIP-2, and Chatgpt summarizes all the information to get the final prompt.

To improve accuracy of generating the image description text, a corresponding guiding rule may be constructed for the generative pre-trained model and a language vision pre-trained model in advance, to guide iterative interactions between the generative pre-trained model and the language vision pre-trained model, and generate the image description text. The guiding rule herein may include a task and a reply rule that are set.

An example in which the generative pre-trained model is the Chatgpt model is used. A task and a reply rule are preset by the Chatgpt model. The set task may be:
I have an image. Ask me questions about the content of this image. Carefully asking me informative questions to maximize your information about this image content. Each time ask one question only without giving an answer. Avoid asking yes/no questions. I'll put my answer beginning with “Answer:”. (That is, I have an image. Ask me questions about the content of this image. Carefully asking me informative questions to maximize your information about this image content. Each time ask one question only without giving an answer. Avoid asking yes/no questions. I'll put my answer beginning with “Answer:”.)

The reply rule may be: Question: <****> Answer: <******>.

A query rule may be: Next Question. Avoid asking yes/no questions. Question:. (Next Question. Avoid asking yes/no questions. Question:.)

An example in which the language vision pre-trained model is the BLIP-2 model is used. Because a large-scale language model used by a BLIP-2 bottom module is almost gpt-2, a task also needs to be clarified for the BLIP-2 model in advance. The set task may be: Answer given questions. If you are not sure about the answer, say you don't know honestly. Don't imagine any contents that are not in the image. (Answer given questions. If you are not sure about the answer, say you don't know honestly. Don't imagine any contents that are not in the image.)

The reply rule may be the same as that of the Chatgpt model, or may be: Question: <****> Answer: <******>.

After the interaction is ended, a final summary may be performed by Chatgpt. A summary rule may be: Now summarize the information you get in a few sentences. Ignore the questions with answers no or not sure. Don't add information. Don't miss information. Summary:. (Now summarize the information you get in a few sentences. Ignore the questions with answers no or not sure. Don't add information. Don't miss information.)

In some embodiments, for prompts summarized by the generative pre-trained model, data augmentation may be performed to a text extent, to increase the quantity of image description texts. An augmentation manner may include, but is not limited to: replacing a word in a prompt, replacing a sentence in the prompt, and performing iterative translation in different languages for multiple times on the prompt, and then translating the prompt into Chinese.

For example, the data augmentation is performed on the obtained prompt to the text degree in the following manners, to obtain a series of prompts:
performing random synonym replacement on a word in a sentence;
performing random antonym replacement on a word in a sentence;
performing random homophone replacement on a word in a sentence;
performing random typo replacement on a word in a sentence;
performing a random position exchange on a word in a sentence;
generating a sentence with a similar meaning to the following sentence; and
first translating a sentence into English, then returning to German, and then translating the sentence into Chinese.

According to this embodiment provided in the present disclosure, the generative pre-trained model generates the image description text based on the image tag of the sample image, so that generation efficiency of the image description text can be improved.

For each of the foregoing method embodiments, for ease of description, the method embodiments are described as a series of action combinations. But a person skilled in the art is to know that the present disclosure is not limited to any described sequence of the action, as some operations can use other sequences or can be executed simultaneously according to the present disclosure. In addition, a person skilled in the art is also to learn that the embodiments described in this specification are all exemplary embodiments, and the involved actions and modules are not necessarily required to the present disclosure.

According to another aspect of the embodiments of the present disclosure, a training apparatus for an image recognition model for implementing the foregoing training method for an image recognition model is further provided. FIG. 11 is a structural block diagram of an exemplary training apparatus for an image recognition model according to an embodiment of the present disclosure. As shown in FIG. 11, the apparatus may include:
an obtaining unit 1102, configured to obtain N sample images in a first sample image set and an image description text and at least one image tag of each of the N sample images;
a first generation unit 1104, connected to the obtaining unit 1102, and configured to: for each sample image, generate, based on the image description text and the at least one image tag of the sample image, a group of image prompts corresponding to the sample image;
a second generation unit 1106, connected to the first generation unit 1104, and configured to: for each sample image, generate, based on the sample image and the group of image prompts, a sample image subset corresponding to the sample image, where the N sample image subsets form a second sample image set; and
a training unit 1108, connected to the second generation unit 1106, and configured to train, by using the first sample image set and the second sample image set, an image recognition model to be trained.

The obtaining unit 1102 in this embodiment may be configured to perform operation S202, the first generation unit 1104 in this embodiment may be configured to perform operation S204, the second generation unit 1106 in this embodiment may be configured to perform operation S206, and the training unit 1108 in this embodiment may be configured to perform operation S208.

In an exemplary solution, the second generation unit includes:
a first execution unit, configured to perform the following operations on an i^{th} sample image and an i^{th} group of image prompts, to obtain an i^{th} sample image subset, where i is a positive integer greater than or equal to 1 and less than or equal to N: pre-obtaining an image representation vector of the i^{th} sample image, and determining an initial hidden space vector of the i^{th} sample image based on the image representation vector; performing noise addition processing on the initial hidden space vector, to obtain a diffuse hidden space vector corresponding to the i^{th} sample image; selecting Mᵢ image prompt subsets to be used from the i^{th} group of image prompts, where Mᵢ is a positive integer greater than or equal to 1; converting each image prompt in the Mᵢ image prompt subsets into a text representation vector, to obtain Mᵢ groups of text representation vectors; and determining, based on the Mᵢ groups of text representation vectors and the diffuse hidden space vector, Mᵢ groups of sample images corresponding to the i^{th} sample image, where the i^{th} sample image subset includes the Mᵢ groups of sample images.

For an exemplary example of this implementation, refer to the examples shown in the foregoing training method for an image recognition model, and details are not described herein again in this implementation.

In an exemplary solution, the first execution unit includes:
a first execution module, configured to perform the following operations on a j^{th} text representation vector of an m^{th} group of text representation vectors of the Mᵢ groups of text representation vectors and the diffuse hidden space vector, to obtain a j^{th} sample image of an m^{th} group of sample images corresponding to the i^{th} sample image, where M is a positive integer greater than or equal to 1 and less than Mᵢ, and j is a positive integer greater than or equal to 1: performing, by using the j^{th} text representation vector and a preset first noise value set, noise reduction processing on the diffuse hidden space vector, to obtain a target hidden space vector; and decoding the target hidden space vector, to obtain the j^{th} sample image.

For an exemplary example of this implementation, refer to the examples shown in the foregoing training method for an image recognition model, and details are not described herein again in this implementation.

In an exemplary solution, the diffuse hidden space vector represents a noise image at a t^{th} moment obtained by adding noise to the i^{th} sample image, and the first execution module includes:
a first execution sub-module, configured to perform, by using the j^{th} text representation vector and the first noise value set, t rounds of iterative noise reduction processing on the diffuse hidden space vector, to obtain the target hidden space vector, where t is a positive integer greater than or equal to 2, and each round of iterative noise reduction processing uses one noise value in the first noise value set.

For an exemplary example of this implementation, refer to the examples shown in the foregoing training method for an image recognition model, and details are not described herein again in this implementation.

In an exemplary solution, the first execution sub-module includes:
an execution sub-unit, configured to perform, by using the following operations, a q^{th} round of iterative noise reduction processing, where a (q−1)^{th} hidden space vector is outputted from a (q−1)^{th} round of iterative noise reduction processing, the (q−1)^{th} hidden space vector is configured for representing a noise image at a (t-q)^{th} moment, and q is a positive integer greater than or equal to 2 and less than or equal to t:
sequentially passing the (q−1)^{th} hidden space vector through P processing units, to obtain a q^{th} hidden space vector, where each processing unit includes a residual network and an attention network that are sequentially connected, an input of the attention network in each processing unit includes the j^{th} text representation vector, an input of the residual network in each processing unit includes a q^{th} noise value in the first noise value set, and P is a positive integer greater than or equal to 2.

For an exemplary example of this implementation, refer to the examples shown in the foregoing training method for an image recognition model, and details are not described herein again in this implementation.

In an exemplary solution, the execution sub-unit includes:
a first execution sub-module, configured to process, by using a first residual network in the first processing unit of the P processing units based on the q^{th} noise value, the (q−1)^{th} hidden space vector, to obtain a residual result outputted by the first residual network;
a second execution sub-module, configured to process, by using the first attention network in the first processing unit, the residual result outputted by the first residual network and the j^{th} text representation vector, to obtain a q₁^{th} hidden space vector outputted by the first attention network;
a third execution sub-module, configured to perform the following operations by using a k^{th} processing unit of the P processing units, where k is a positive integer greater than or equal to 2 and less than or equal to P:
processing, by using a k^{th} residual network in the k^{th} processing unit based on the q^{th} noise value, a qₖ₋₁^{th} hidden space vector outputted by a (k−1)^{th} attention network in a (k−1)^{th} processing unit, to obtain a residual result outputted by the k^{th} residual network; and
processing, by using a k^{th} attention network in the k^{th} processing unit, the residual result outputted by the k^{th} residual network and the j^{th} text representation vector, to obtain a qₖ^{th} hidden space vector outputted by the k^{th} attention network, where when k is equal to P, the q^{th} hidden space vector is a q_{P}^{th} hidden space vector outputted by a P^{th} attention network.

For an exemplary example of this implementation, refer to the examples shown in the foregoing training method for an image recognition model, and details are not described herein again in this implementation.

In an exemplary solution, the first execution unit includes:
a second execution module, configured to process the image representation vector by using a convolution layer and a fully-connected layer in a residual network, to obtain the initial hidden space vector of the i^{th} sample image.

For an exemplary example of this implementation, refer to the examples shown in the foregoing training method for an image recognition model, and details are not described herein again in this implementation.

In an exemplary solution, the first execution unit includes:
a decoding module, configured to decode the initial hidden space vector, to obtain an i^{th} to-be-processed image corresponding to the i^{th} sample image;
a first encoding module, configured to encode the i^{th} to-be-processed image, to obtain an image representation vector of the i^{th} to-be-processed image; and
a third execution module, configured to perform noise addition processing on the image representation vector of the i^{th} to-be-processed image, to obtain the diffuse hidden space vector corresponding to the i^{th} sample image.

For an exemplary example of this implementation, refer to the examples shown in the foregoing training method for an image recognition model, and details are not described herein again in this implementation.

In an exemplary solution, the third execution module includes:
a second execution sub-module, configured to perform, by using a preset second noise value set, t rounds of iterative noise addition processing on the image representation vector of the i^{th} to-be-processed image, to obtain the diffuse hidden space vector corresponding to the i^{th} sample image, where t is a positive integer greater than or equal to 2, and each round of iterative noise addition processing uses a corresponding noise value in the second noise value set.

For an exemplary example of this implementation, refer to the examples shown in the foregoing training method for an image recognition model, and details are not described herein again in this implementation.

In an exemplary solution, the first execution unit includes:
a second encoding module, configured to encode, by using a target text encoder, each image prompt in the Mᵢ image prompt subsets, to obtain the Mᵢ groups of text representation vectors.

In an exemplary solution, the second execution module is configured to encode the i^{th} sample image by using a target image encoder, to obtain the image representation vector.

The target text encoder and the target image encoder are encoders obtained by performing joint training on a to-be-trained text encoder and a to-be-trained image encoder.

The target text encoder and the target image encoder meet the following conditions. A similarity between a first text representation vector and a first image representation vector is less than or equal to a preset first threshold. The first text representation vector is a vector obtained by encoding text information in a first group of information by the target text encoder. The first image representation vector is a vector obtained by encoding an image in the first group of information by the target image encoder. The text information in the first group of information does not match the image. A similarity between a second text representation vector and a second image representation vector is greater than or equal to a preset second threshold. The second text representation vector is a vector obtained by encoding text information in a second group of information by the target text encoder. The second image representation vector is a vector obtained by encoding an image in the second group of information by the target image encoder. The text information in the second group of information matches the image, and the second threshold is greater than the first threshold.

For an exemplary example of this implementation, refer to the examples shown in the foregoing training method for an image recognition model, and details are not described herein again in this implementation.

In an exemplary solution, the first generation unit includes:
a fourth execution module, configured to input, as a target question, the image description text and an i^{th} image tag to a generative pre-trained model, to obtain an i^{th} image prompt, where the generative pre-trained model is configured for generating a corresponding answer based on an inputted question, and i is a positive integer greater than or equal to 1.

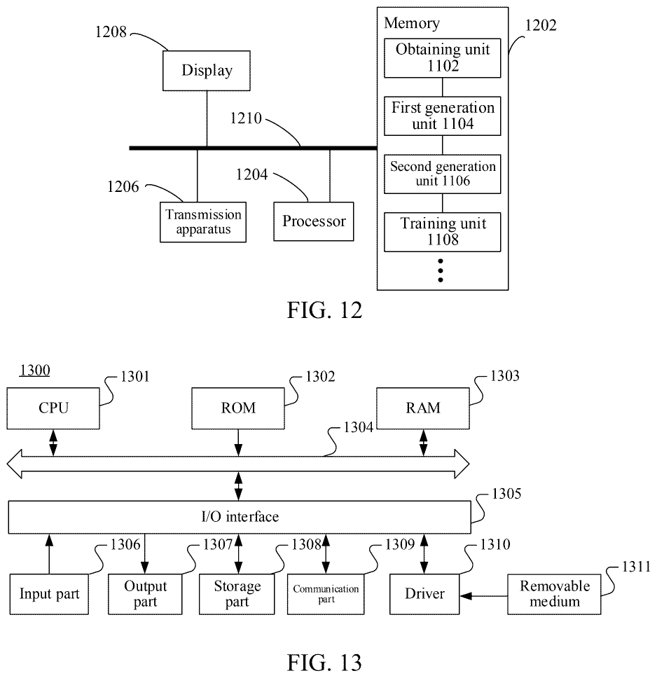

According to still another aspect of the embodiments of the present disclosure, an electronic device for implementing the foregoing training method for an image recognition model is further provided. The electronic device may be the terminal device or the server shown in FIG. 1. This embodiment is described by using an example in which the electronic device is the terminal device. As shown in FIG. 12, the electronic device includes a memory 1202 and a processor 1204. The memory 1202 has a computer program stored therein, and the processor 1204 is configured to perform operations in any of the foregoing method embodiments by using the computer program.

In this embodiment, the electronic device may be located in at least one of a plurality of network devices in a computer network.

In this embodiment, the processor may be configured to perform the method described in the foregoing embodiment by using the computer program.

In some embodiments, a person of ordinary skill in the art may understand that, the structure shown in FIG. 12 is only an example. The electronic device may be a terminal device such as a smartphone (for example, an Android mobile phone or an iOS mobile phone), a tablet computer, a palmtop computer, a mobile internet device (MID), or a PAD. The structure of the foregoing electronic device is not limited in FIG. 12. For example, the electronic device may further include more or less components (for example, a network interface) than those shown in FIG. 12, or has a configuration different from that shown in FIG. 12.

The memory 1202 may be configured to store a software program and a module, such as program instructions/modules corresponding to the training method and apparatus for an image recognition model in the embodiments of the present disclosure. The processor 1204 runs the software program and the module stored in the memory 1202, to perform various function applications and data processing, in other words, implement the foregoing training method for an image recognition model. The memory 1202 may include a high-speed random access memory, and may further include a non-volatile memory, such as one or more magnetic storage apparatuses, a flash memory, or another non-volatile solid-state memory. In some examples, the memory 1202 may further include memories remotely arranged relative to the processor 1204, and the remote memories may be connected to a terminal through a network. Examples of the network include, but are not limited to, an internet, an intranet, a local area network, a mobile communication network, and a combination thereof. The memory 1202 may be specifically used for, but not limited to, a serialization file, a compilation file, and other information.

As an example, as shown in FIG. 12, the memory 1202 may include, but is not limited to, the obtaining unit 1102, the first generation unit 1104, the second generation unit 1106, and the training unit 1108 in the training apparatus for an image recognition model. In addition, the memory may further include, but is not limited to, other modules and units in the training apparatus for an image recognition model. Details are not described again in this example.

In some embodiments, a transmission apparatus 1206 is configured to receive or transmit data through a network. Specific examples of the network may include a wired network and a wireless network. In an example, the transmission apparatus 1206 includes a network interface controller (NIC). The network interface controller may be connected to another network device and a router by using a network cable, to communicate with the internet or the local area network. In an example, the transmission apparatus 1206 is a radio frequency (RF) module. The radio frequency module communicates with the internet in a wireless manner.

In addition, the electronic device further includes: a display 1208, configured to display a display interface of a game application; and a connection bus 1210, configured to connect to each module component in the electronic device.

In some other embodiments, the foregoing terminal device or server may be a node in a distributed system. The distributed system may be a blockchain system, and the blockchain system may be a distributed system formed by connecting a plurality of nodes through network communication. A peer to peer (P2P) network may be formed between the nodes. A computing device in any form, for example, an electronic device such as a server or a terminal, may become a node in the blockchain system by joining the peer to peer network.

According to an aspect of the present disclosure, a computer program product is provided. The computer program product includes computer programs/instructions, and the computer programs/instructions include program code configured for performing the method shown in the flowchart. In such an embodiment, the computer program may be downloaded and installed through a communication part 1309 from a network, and/or installed from a removable medium 1311. When the computer program is executed by a central processing unit 1301, various functions provided in the embodiments of the present disclosure are performed. The sequence numbers of the foregoing embodiments of the present disclosure are merely for illustrative purposes, and are not intended to indicate priorities of the embodiments.

FIG. 13 schematically shows a structural block diagram of a computer system configured to implement an exemplary electronic device according to an embodiment of the present disclosure. As shown in FIG. 13, a computer system 1300 includes the central processing unit (CPU) 1301, which may execute various proper actions and processing based on a program stored in a read-only memory (ROM) 1302 or a program loaded from a storage part 1308 into a random access memory (RAM) 1303. The random access memory 1303 further stores various programs and data required by system operations. The central processing unit 1301, the read-only memory 1302, and the random access memory 1303 are connected to each other via a bus 1304. An input/output (I/O) interface 1305 is also connected to the bus 1304.

The following components are connected to the input/output interface 1305: an input part 1306 including a keyboard, a mouse, or the like; an output part 1307 including a cathode ray tube (CRT), a liquid crystal display (LCD), a speaker, or the like; a storage part 1308 including a hard disk or the like; and a communication part 1309 of a network interface card, including a local area network card, a modem, or the like. The communication part 1309 performs communication processing by using a network such as the internet. A driver 1310 is also connected to the input/output interface 1305 as required. The removable medium 1311, such as a magnetic disk, an optical disc, a magneto-optical disk, or a semiconductor memory, is installed on the driver 1310 as required, so that a computer program read from the removable medium is installed into the storage part 1308 as required.

Particularly, according to the embodiments of the present disclosure, the processes described in the various method flowcharts may be implemented as computer software programs. For example, this embodiment of the present disclosure includes a computer program product, the computer program product includes a computer program carried on a computer-readable medium, and the computer program includes program code configured for performing the methods shown in the flowcharts. In such an embodiment, the computer program may be downloaded and installed through the communication part 1309 from the network, and/or installed from the removable medium 1311. When the computer program is executed by the central processing unit 1301, various functions defined in the system of the present disclosure are performed.

The computer system 1300 of the electronic device shown in FIG. 13 is merely an example, and does not constitute any limitation on functions and use ranges of the embodiments of the present disclosure.

According to an aspect of the present disclosure, a computer-readable storage medium is provided. A processor of a computer device reads computer instructions from the computer-readable storage medium. The processor executes the computer instructions to enable the computer device to perform the method provided in various exemplary implementations in the foregoing embodiments.

In this embodiment, the computer-readable storage medium may be configured to store a computer program configured for performing the steps in the foregoing embodiments.

In this embodiment, a person of ordinary skill in the art may understand that all or part of the steps of the methods in the foregoing embodiments may be implemented by a program instructing hardware relevant to a terminal device. The program may be stored in a computer-readable storage medium, and the storage medium may include: a flash drive, a read-only memory (ROM), a random access memory (RAM), a magnetic disk, an optical disk, and the like.

When the integrated unit of the foregoing embodiments is implemented in the form of a software functional unit and sold or used as an independent product, the integrated unit may be stored in the foregoing computer-readable storage medium. Based on such an understanding, the technical solutions of the present disclosure essentially, or a part contributing to the related technology, or all or a part of the technical solution may be implemented in a form of a software product. The computer software product is stored in a storage medium and includes several instructions for instructing one or more computer devices (which may be a personal computer, a server, a network device, or the like) to perform all or some of steps of the foregoing methods in the embodiments of the present disclosure.

In the foregoing embodiments of the present disclosure, the descriptions of the embodiments have their respective focuses. For a part that is not described in detail in an embodiment, refer to related descriptions in other embodiments.

In the several embodiments provided in the present disclosure, the disclosed client may be implemented in other manners. The described apparatus embodiments are merely exemplary. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electrical or other forms.

The units described as separate parts may or may not be physically separate. Parts displayed as units may or may not be physical units, and may be located in one position, or may be distributed on a plurality of network units. Some or all of the units may be selected based on actual needs, so as to achieve the objective of the solution of the embodiments.

In addition, functional units in the embodiments of the present disclosure may be integrated into one processing unit, or each of the units may be physically separated, or at least two units may be integrated into one unit. The integrated unit may be implemented in a form of hardware or a software function unit.

The foregoing descriptions are merely exemplary embodiments of the present disclosure, and a person of ordinary skill in the art may make various improvements and modifications without departing from the principle of the present disclosure. All such improvements and modifications shall fall within the protection scope of the present disclosure.

1. A training method for an image recognition model, performed by an electronic device, and comprising:
obtaining N sample images in a first sample image set and an image description text and at least one image tag of each of the N sample images;
generating, for each sample image, based on the image description text and the at least one image tag of the sample image, a group of image prompts corresponding to the sample image;
generating, for each sample image, based on the sample image and the group of image prompts, a sample image subset corresponding to the sample image, to obtain N sample image subsets, wherein the N sample image subsets form a second sample image set; and
training, by using the first sample image set and the second sample image set, an image recognition model to be trained.

2. The method according to claim 1, wherein the generating, based on the sample image and the group of image prompts, a sample image subset corresponding to the sample image comprises:
performing the following operations on an i^{th} sample image and an i^{th} group of image prompts, to obtain an i^{th} sample image subset, i being a positive integer less than or equal to N:
obtaining an image representation vector of the i^{th} sample image, and determining an initial hidden space vector of the i^{th} sample image based on the image representation vector;
adding noise to the initial hidden space vector, to obtain a diffuse hidden space vector corresponding to the i^{th} sample image;
selecting Mᵢ image prompt subsets to be used from the i^{th} group of image prompts, Mᵢ being a positive integer;
converting each image prompt in the Mᵢ image prompt subsets into a text representation vector, to obtain Mᵢ groups of text representation vectors; and
determining, based on the Mᵢ groups of text representation vectors and the diffuse hidden space vector, Mᵢ groups of sample images corresponding to the i^{th} sample image, wherein the i^{th} sample image subset comprises the Mᵢ groups of sample images.

3. The method according to claim 2, wherein the determining, based on the Mᵢ groups of text representation vectors and the diffuse hidden space vector, Mᵢ groups of sample images corresponding to the i^{th} sample image comprises:
performing the following operations on a j^{th} text representation vector of an m^{th} group of text representation vectors of the Mᵢ groups of text representation vectors and the diffuse hidden space vector, to obtain a j^{th} sample image of an m^{th} group of sample images corresponding to the i^{th} sample image, M being a positive integer less than Mᵢ, and j being a positive integer:
performing, by using the j^{th} text representation vector and a preset first noise value set, noise reduction processing on the diffuse hidden space vector, to obtain a target hidden space vector; and
decoding the target hidden space vector, to obtain the j^{th} sample image.

4. The method according to claim 3, wherein the diffuse hidden space vector represents a noise image at a t^{th} moment obtained by adding noise to the i^{th} sample image, and the performing, by using the j^{th} text representation vector and a preset first noise value set, noise reduction processing on the diffuse hidden space vector, to obtain a target hidden space vector comprises:
performing, by using the j^{th} text representation vector and the first noise value set, t rounds of iterative noise reduction processing on the diffuse hidden space vector, to obtain the target hidden space vector, t being a positive integer greater than or equal to 2, and each round of iterative noise reduction processing using one noise value in the first noise value set.

5. The method according to claim 4, wherein the performing, by using the j^{th} text representation vector and the first noise value set, t rounds of iterative noise reduction processing on the diffuse hidden space vector, to obtain the target hidden space vector comprises:
performing, by using the following operations, a q^{th} round of iterative noise reduction processing, a (q−1)^{th} hidden space vector being outputted from a (q−1)^{th} round of iterative noise reduction processing, the (q−1)^{th} hidden space vector representing a noise image at a (t−q)^{th} moment, and q being a positive integer greater than or equal to 2 and less than or equal to t:
sequentially passing the (q−1)^{th} hidden space vector through P processing units, to obtain a q^{th} hidden space vector, each of the P processing units comprising a residual network and an attention network that are sequentially connected, an input of the attention network in each processing unit comprising the j^{th} text representation vector, an input of the residual network in each processing unit comprising a q^{th} noise value in the first noise value set, and P being a positive integer greater than or equal to 2.

6. The method according to claim 5, wherein the sequentially passing the (q−1)^{th} hidden space vector through P processing units, to obtain a q^{th} hidden space vector comprises:
processing, by using a first residual network in the first processing unit of the P processing units based on the q^{th} noise value, the (q−1)^{th} hidden space vector, to obtain a residual result outputted by the first residual network;
processing, by using a first attention network in the first processing unit, the residual result outputted by the first residual network and the j^{th} text representation vector, to obtain a q₁^{th} hidden space vector outputted by the first attention network; and
performing the following operations by using a k^{th} processing unit of the P processing units, k being a positive integer greater than or equal to 2 and less than or equal to P:
processing, by using a k^{th} residual network in the k^{th} processing unit based on the q^{th} noise value, a qₖ₋₁^{th} hidden space vector outputted by a (k−1)^{th} attention network in a (k−1)^{th} processing unit, to obtain a residual result outputted by the k^{th} residual network; and
processing, by using a k^{th} attention network in the k^{th} processing unit, the residual result outputted by the k^{th} residual network and the j^{th} text representation vector, to obtain a qₖ^{th} hidden space vector outputted by the k^{th} attention network, when k is equal to P, the q^{th} hidden space vector being a q_{P}^{th} hidden space vector outputted by a P^{th} attention network.

7. The method according to claim 2, wherein the determining an initial hidden space vector of the i^{th} sample image based on the image representation vector comprises:
processing the image representation vector by using a convolution layer and a fully-connected layer in a residual network, to obtain the initial hidden space vector of the i^{th} sample image.

8. The method according to claim 2, wherein the adding noise on the initial hidden space vector, to obtain a diffuse hidden space vector corresponding to the i^{th} sample image comprises:
decoding the initial hidden space vector, to obtain an i^{th} image to be processed corresponding to the i^{th} sample image;
encoding the i^{th} image, to obtain an image representation vector of the it to-be-processed image; and
performing noise addition processing on the image representation vector of the i^{th} image, to obtain the diffuse hidden space vector corresponding to the i^{th} sample image.

9. The method according to claim 8, wherein the performing noise addition processing on the image representation vector of the i^{th} image, to obtain the diffuse hidden space vector corresponding to the i^{th} sample image comprises:
performing, by using a preset second noise value set, t rounds of iterative noise addition processing on the image representation vector of the i^{th} image, to obtain the diffuse hidden space vector corresponding to the i^{th} sample image, t being a positive integer greater than or equal to 2, and each round of iterative noise addition processing using a corresponding noise value in the second noise value set.

10. The method according to claim 2, wherein the converting each image prompt in the Mᵢ image prompt subsets into a text representation vector, to obtain Mᵢ groups of text representation vectors comprises:
encoding, by using a target text encoder, each image prompt in the Mᵢ image prompt subsets, to obtain the Mᵢ groups of text representation vectors.

11. The method according to claim 10, wherein the obtaining an image representation vector of the i^{th} sample image comprises:
encoding the i^{th} sample image by using a target image encoder, to obtain the image representation vector,
the target text encoder and the target image encoder being encoders obtained by performing joint training on a to-be-trained text encoder and a to-be-trained image encoder; and
during training, the target text encoder and the target image encoder meeting the following conditions:
a similarity between a first text representation vector and a first image representation vector is less than or equal to a preset first threshold, the first text representation vector is a vector obtained by encoding text information in a first group of information by the target text encoder, the first image representation vector is a vector obtained by encoding an image in the first group of information by the target image encoder, and the text information in the first group of information does not match the image; and
a similarity between a second text representation vector and a second image representation vector is greater than or equal to a preset second threshold, the second text representation vector is a vector obtained by encoding text information in a second group of information by the target text encoder, the second image representation vector is a vector obtained by encoding an image in the second group of information by the target image encoder, the text information in the second group of information matches the image, and the second threshold is greater than the first threshold.

12. The method according to claim 1, wherein the generating, based on the image description text and the at least one image tag of the sample image, a group of image prompts corresponding to the sample image comprises:
inputting, as a target question, the image description text and an i^{th} image tag to a generative pre-trained model, to obtain an i^{th} image prompt, the generative pre-trained model being configured for generating a corresponding answer based on an inputted question, and i being a positive integer.

13. A non-transitory computer-readable storage medium, comprising a stored program, the program, when run by at least one processor, causing the at least one processor to perform:
obtaining N sample images in a first sample image set and an image description text and at least one image tag of each of the N sample images;
generating, for each sample image, based on the image description text and the at least one image tag of the sample image, a group of image prompts corresponding to the sample image;
generating, for each sample image, based on the sample image and the group of image prompts, a sample image subset corresponding to the sample image, to obtain N sample image subsets, wherein the N sample image subsets form a second sample image set; and
training, by using the first sample image set and the second sample image set, an image recognition model to be trained.

14. The storage medium according to claim 13, wherein the generating, based on the sample image and the group of image prompts, a sample image subset corresponding to the sample image comprises:
performing the following operations on an i^{th} sample image and an i^{th} group of image prompts, to obtain an i^{th} sample image subset, i being a positive integer less than or equal to N:
obtaining an image representation vector of the i^{th} sample image, and determining an initial hidden space vector of the i^{th} sample image based on the image representation vector;
adding noise to the initial hidden space vector, to obtain a diffuse hidden space vector corresponding to the i^{th} sample image;
selecting Mᵢ image prompt subsets to be used from the i^{th} group of image prompts, Mᵢ being a positive integer;
converting each image prompt in the Mᵢ image prompt subsets into a text representation vector, to obtain Mᵢ groups of text representation vectors; and
determining, based on the Mᵢ groups of text representation vectors and the diffuse hidden space vector, Mᵢ groups of sample images corresponding to the i^{th} sample image, wherein the i^{th} sample image subset comprises the Mᵢ groups of sample images.

15. The storage medium according to claim 14, wherein the determining, based on the Mᵢ groups of text representation vectors and the diffuse hidden space vector, Mᵢ groups of sample images corresponding to the i^{th} sample image comprises:
performing the following operations on a j^{th} text representation vector of an m^{th} group of text representation vectors of the Mᵢ groups of text representation vectors and the diffuse hidden space vector, to obtain a j^{th} sample image of an m^{th} group of sample images corresponding to the i^{th} sample image, M being a positive integer less than Mᵢ, and j being a positive integer:
performing, by using the j^{th} text representation vector and a preset first noise value set, noise reduction processing on the diffuse hidden space vector, to obtain a target hidden space vector; and
decoding the target hidden space vector, to obtain the j^{th} sample image.

16. The storage medium according to claim 15, wherein the diffuse hidden space vector represents a noise image at a t^{th} moment obtained by adding noise to the i^{th} sample image, and the performing, by using the j^{th} text representation vector and a preset first noise value set, noise reduction processing on the diffuse hidden space vector, to obtain a target hidden space vector comprises:
performing, by using the j^{th} text representation vector and the first noise value set, t rounds of iterative noise reduction processing on the diffuse hidden space vector, to obtain the target hidden space vector, t being a positive integer greater than or equal to 2, and each round of iterative noise reduction processing using one noise value in the first noise value set.

17. The storage medium according to claim 16, wherein the performing, by using the j^{th} text representation vector and the first noise value set, t rounds of iterative noise reduction processing on the diffuse hidden space vector, to obtain the target hidden space vector comprises:
performing, by using the following operations, a q^{th} round of iterative noise reduction processing, a (q−1)^{th} hidden space vector being outputted from a (q−1)^{th} round of iterative noise reduction processing, the (q−1)^{th} hidden space vector representing a noise image at a (t-q)^{th} moment, and q being a positive integer greater than or equal to 2 and less than or equal to t:
sequentially passing the (q−1)^{th} hidden space vector through P processing units, to obtain a q^{th} hidden space vector, each of the P processing units comprising a residual network and an attention network that are sequentially connected, an input of the attention network in each processing unit comprising the j^{th} text representation vector, an input of the residual network in each processing unit comprising a q^{th} noise value in the first noise value set, and P being a positive integer greater than or equal to 2.

18. The storage medium according to claim 17, wherein the sequentially passing the (q−1)^{th} hidden space vector through P processing units, to obtain a q^{th} hidden space vector comprises:
processing, by using a first residual network in the first processing unit of the P processing units based on the q^{th} noise value, the (q−1)^{th} hidden space vector, to obtain a residual result outputted by the first residual network;
processing, by using a first attention network in the first processing unit, the residual result outputted by the first residual network and the j^{th} text representation vector, to obtain a q₁^{th} hidden space vector outputted by the first attention network; and
performing the following operations by using a k^{th} processing unit of the P processing units, k being a positive integer greater than or equal to 2 and less than or equal to P:
processing, by using a k^{th} residual network in the k^{th} processing unit based on the q^{th} noise value, a qₖ₋₁^{th} hidden space vector outputted by a (k−1)^{th} attention network in a (k−1)^{th} processing unit, to obtain a residual result outputted by the k^{th} residual network; and
processing, by using a k^{th} attention network in the k^{th} processing unit, the residual result outputted by the k^{th} residual network and the j^{th} text representation vector, to obtain a qₖ^{th} hidden space vector outputted by the k^{th} attention network, when k is equal to P, the q^{th} hidden space vector being a q_{P}^{th} hidden space vector outputted by a P^{th} attention network.

19. The storage medium according to claim 14, wherein the determining an initial hidden space vector of the i^{th} sample image based on the image representation vector comprises:
processing the image representation vector by using a convolution layer and a fully-connected layer in a residual network, to obtain the initial hidden space vector of the i^{th} sample image.

20. An electronic device, comprising a memory and a processor, the memory having a computer program stored therein, and the processor being configured to execute the computer program and perform:
obtaining N sample images in a first sample image set and an image description text and at least one image tag of each of the N sample images;
generating, for each sample image, based on the image description text and the at least one image tag of the sample image, a group of image prompts corresponding to the sample image;
generating, for each sample image, based on the sample image and the group of image prompts, a sample image subset corresponding to the sample image, to obtain N sample image subsets, wherein the N sample image subsets form a second sample image set; and
training, by using the first sample image set and the second sample image set, an image recognition model to be trained.
